(19) United States
(12) Patent Application Publication
(10) Pub. No.: US 2019/0227569 A1
(43) Pub. Date: Jul. 25, 2019

(54) Task Management Platform for Autonomous Vehicles

(71) Applicant: Uber Technologies, Inc., San Francisco, CA (US)

(72) Inventors: Emily Anna Weslosky, San Francisco, CA (US); Gary Wu Yang, San Francisco, CA (US); Nuri Kim, San Francisco, CA (US); Anand Nandakumar, San Francisco, CA (US); Varun Rau, San Francisco, CA (US); Mark Russell Reeder, Menlo Park, CA (US); Robert Eperjesi, San Francisco, CA (US)

(21) Appl. No.: 15/907,829

(22) Filed: Feb. 28, 2018

Related U.S. Application Data
(60) Provisional application No. 62/619,147, filed on Jan. 19, 2018.

(51) Int. Cl. G05D 1/02; G07C 5/00; G07C 5/08; G05D 1/00

(52) U.S. Cl. CPC G05D 1/0291; G07C 5/008; G05D 2201/0213; G05D 1/0088; G07C 5/0841; G07C 5/0808

(57) ABSTRACT

Systems and methods are directed to a task management platform for managing autonomous vehicles. In one example, a computer-implemented method for managing a fleet of vehicles includes obtaining, by a computing system comprising one or more computing devices, vehicle state data indicative of vehicle state from one or more vehicles among a fleet of vehicles. The method further includes determining, by the computing system, if a vehicle event has occurred based at least in part on the vehicle state data. The method further includes in response to determining a vehicle event has occurred, generating, by the computing system, one or more tasks for resolution of the vehicle event, wherein the one or more tasks include data associated with the one or more vehicles and the vehicle event. The method further includes providing, by the computing system, data associated with the one or more tasks to a remote operator computing system.

The present application is based on and claims the benefit of U.S. Provisional Application 62/619,147 having a filing date of Jan. 19, 2018, which is incorporated by reference herein.

### FIELD

The present disclosure relates generally to autonomous vehicles. More particularly, the present disclosure relates to systems and methods that provide for remote management of vehicles within a fleet.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether. An entity (e.g., service provider, owner, manager) can use one or more vehicles (e.g., autonomous ground-based vehicles, etc.) to provide a vehicle service such as a transportation service (e.g., rideshare service), a courier service, a delivery service, etc.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for managing a fleet of vehicles. The method includes obtaining, by a computing system comprising one or more computing devices, vehicle state data indicative of vehicle state from one or more vehicles among a fleet of vehicles. The method further includes determining, by the computing system, if a vehicle event has occurred based at least in part on the vehicle state data. The method further includes in response to determining a vehicle event has occurred, generating, by the computing system, one or more tasks for resolution of the vehicle event, wherein the one or more tasks include data associated with the one or more vehicles and the vehicle event. The method further includes providing, by the computing system, data associated with the one or more tasks to a remote operator computing system.

Another example aspect of the present disclosure is directed to a system. The system includes one or more processors and one or more memories including instructions that, when executed by the one or more processors, cause the one or more processors to perform operations. The operations include obtaining vehicle state data indicative of vehicle state from one or more vehicles among a fleet of vehicles. The operations further include determining if a vehicle event has occurred based at least in part on the vehicle state data. The operations further include in response to determining a vehicle event has occurred, generating one or more tasks for resolution of the vehicle event, wherein the one or more tasks include data associated with the one or more vehicles and the vehicle event. The operations further providing data associated with the one or more tasks to a remote operator computing system.

Another example aspect of the present disclosure is directed to one or more tangible, non-transitory computer-readable media storing computer-readable instructions that when executed by one or more processors cause the one or more processors to perform operations. The operations include obtaining vehicle data indicative of vehicle state from one or more vehicles among a fleet of vehicles. The operations further include determining if a vehicle event has occurred based at least in part on the vehicle state data. The operations further include in response to determining a vehicle event has occurred, generating one or more tasks for resolution of the vehicle event, wherein the one or more tasks include data associated with the one or more vehicles and the vehicle event. The operations further providing data associated with the one or more tasks to a remote operator computing system.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of an autonomous vehicle according to example embodiments of the present disclosure;

FIG. 2 depicts a block diagram of an example computing system according to example embodiments of the present disclosure;

FIG. 3 depicts a flowchart diagram of example operations for a task management platform according to example embodiments of the present sure;

FIG. 4 depicts a block diagram of an example system according to example embodiments of the present disclosure;

FIG. 5 depicts an example display interface for task queuing according to example embodiments of the present disclosure;

FIG. 6 depicts an example display interface for task resolution according to example embodiments of the present disclosure; and

FIG. 7 depicts an example display interface for reporting according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to remote management of vehicles within a fleet. In particular, the systems and methods of the present disclosure can allow for monitoring the health of vehicles across the entire fleet. The systems and methods of the present disclosure can facilitate detection of vehicle events within the fleet and provide for managing tasks related to detected vehicle events. The systems and methods of the present disclosure can provide task workflow capabilities, such as task queuing, prioritization, routing, escalation, analytics, and reporting, for managing vehicles across the entire fleet. As such, systems and methods can be provided that advantageously implement a task management platform that streamlines vehicle readiness workflows across a fleet of vehicles.

In particular, an entity (e.g., service provider, owner, manager) can use one or more vehicles (e.g., ground-based vehicles) to perform one or more tasks from a set of predetermined tasks. The set of predetermined tasks can include, for example, providing a vehicle service such as a transportation service (e.g., rideshare service), a courier service, a delivery service, etc.

The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can receive sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment.

Moreover, the autonomous vehicle can be configured to communicate with one or more computing devices that are remote from the vehicle. For example, the autonomous vehicle can communicate with an operations computing system that can be associated with the entity. The operations computing system can help the entity monitor, communicate with, manage, etc. the fleet of vehicles.

More particularly, the systems and methods of the present disclosure can provide a task management platform offering core task workflow capabilities, such as queuing, prioritization, routing, escalation, analytics, and reporting. According to an aspect of the present disclosure, the task management platform can provide for obtaining vehicle data associated with vehicles within a fleet of vehicles. For example, in some implementations, a vehicle application programming interface (API) platform can provide for a translation/transport layer as an interface between vehicle computing systems onboard vehicles within an entity's fleet and one or more remote clients and/or applications operating within the entity's operations/control center. The task management platform can perform anomaly detection to identify vehicle events based at least in part on the vehicle data. The task management platform can provide for generating one or more task workflows associated with a vehicle event and queuing the tasks for remote operators.

According to another aspect of the present disclosure, the task management platform can provide an interface to other applications operating within the entity's operations/control center (e.g., allow other operations applications to plug-in to the task management platform) to allow for leveraging the capabilities of other applications in managing task workflows (e.g., provide capabilities for issue resolution and/or the like). For example, in some implementations, the task management platform can access one or more other applications/services operating within an entity's operations/control center (e.g., fleet management, fleet maintenance, etc.) and obtain data and/or provide access to application functionality for use in handling tasks.

More particularly, according to an aspect of the present disclosure, a task management platform can communicate with one or more vehicles (e.g., vehicle computing system, etc.) within an entity's fleet and/or one or more applications operating within an entity's operations/control center to provide for the detection of vehicle events associated with one or more vehicles within the entity's fleet. In some implementations, a vehicle API platform and/or the like can allow for a vehicle to send data including vehicle state information and/or the like (“vehicle state data”) associated with the vehicle at one or more times. The vehicle state data can include, for example, vehicle activity information, vehicle schedule information, trip availability information, vehicle readiness information, vehicle ownership information, vehicle failure/error data, and/or the like. In some implementations, the vehicle state data can be used in part in determining whether a vehicle event has occurred, such as when vehicle metrics deviate from normal or historical trends.

In some implementations, the task management platform can communicate with one or more applications and/or services, for example, operating within the entity's operations/control center and/or the like, to obtain operational data for use in determining vehicle events and/or tasks associated with vehicle events. For example, the task management platform can obtain data from other applications and/or services (e.g., fleet management, fleet maintenance, etc.), such as vehicle service history, vehicle recall information, fleet metrics, operating parameters, and/or the like, to assist in determining whether one or more tasks should be generated in regard to a detected vehicle event.

According to another aspect of the present disclosure, the task management platform can generate one or more tasks based in part on the vehicle event(s). In some implementations, the task management platform can provide data to the one or more vehicles (e.g., vehicle computing system, etc.) for use in resolving issues associated with the vehicle event(s). As an example, a vehicle event can be an indication that a check engine light has been triggered in a vehicle. The check engine light vehicle event could trigger a fleet management task, which may then be escalated or routed to fleet services such that a required part can be ordered. Once the part order has been received, the vehicle could be scheduled for maintenance.

In some implementations, the task management platform can provide for recognizing a vehicle event and generating tasks for remote operators. The task management platform can facilitate monitoring fleet health, for example using real-time dashboards, and can provide for alerts when key metrics deviate from normal or historical trends, as identified via anomaly detection. In some embodiments, the task management platform can categorize, prioritize and queue tasks associated with vehicle events.

In some implementations, the task management platform can route tasks to one or more remote operators based in part on skill sets associated with the remote operators. In some implementations, the task management platform can provide for generating profiles for remote operators, for example, to maintain historical and reporting data for remote operators. In some implementations, the task management platform can provide for generating and/or associating one or more skill sets for a remote operator (e.g., in an operator profile, etc.) to facilitate routing tasks to a remote operator.

According to an aspect of the present disclosure, a task management platform can provide for remote operators to view, sort, and/or filter assigned tasks. For example, in some implementations, the task management platform can provide a list view of assigned tasks, and display associated task information, such as application, task title, task identifier (e.g., task number), associated vehicle, vehicle location (e.g., city, etc.), vehicle mission, vehicle system information (e.g., current system release, etc.), task status (e.g., opened, closed, duration, etc.), assigned operator, and/or the like. In some implementations, the task management platform can provide for automatically assigning tasks to a remote operator automatically, for example, based on availability, associated skill set, and/or the like. In some implementations, the task management platform can provide for reassigning tasks to another operator, for example, as a result of change in availability and/or the like. In some implementations, the task management platform can provide a queue display to provide a view of assigned tasks which can include information for each queued task, such as a task identifier, task title, timestamp (e.g., when task was generated, when status changed, etc.), task status, a vehicle identifier, and/or the like.

According to another aspect of the present disclosure, a task management platform can provide interfaces to one or more other operations applications (e.g., operating within the entity's operations/control center, etc.), for example, to facilitate resolving and/or escalating a task. For example, in some implementations, the task management platform can access one or more other applications/services and obtain data and/or provide access to application functionality for use in handling tasks. In some implementations, the task management platform can provide an interface to one or more application-specific components, for example, external video, internal video, vehicle diagnostics, inventory data, and/or the like.

In some implementations, the task management platform can provide common display header data associated with a task as part of an interface for an operations application. For example, in some implementations, the task management platform can populate an application interface header with data indicative of tasks associated with the application, such as ticket identifier, status (e.g., online, offline, etc.), number of tickets in queue, and/or the like.

In some implementations, the task management platform can provide an application interface to access application data and capabilities related to fleet management such as vehicle information, troubleshooter information/capabilities, vehicle history, task log, resolution, the ability to reassign and/or escalate a task, and/or the like. In some implementations, the task management platform can provide for displaying key task and/or vehicle information associated with the application. For example, the interface can provide for the display of task information such as task number, task title, task category, task priority, and/or the like. As another example, the task management platform application interface can provide for the display of vehicle information such as vehicle identifier (e.g., alias, etc.), current city, mission, operators, links, troubleshooter/update capability, and/or the like. In some implementations, the application interface can provide for accessing a task history for a vehicle, for example, providing a view of all tasks associated with the vehicle over a defined period (e.g., last three tasks, tasks in last 30 days, etc.).

In some implementations, the task management platform application interface can provide for facilitating one or more actions related to a task. For example, a task management platform application interface can provide the ability to execute a command remotely to troubleshoot and/or resolve an issue, update one or more diagnostics, view a history of vehicle diagnostic snapshots, access one or more knowledge bases, escalate a task, record a task resolution, reopen a task, and/or the like. In some implementations, the task management platform can provide for a task log to allow for logging all associated tasks and/or actions, and can provide for capturing comments related to a task/action.

In some implementations, the task management platform can provide an application interface to access application data and capabilities for pre and/or post assignment vehicle checks such as vehicle information, pre-assignment check, post-assignment check, access vehicle cameras and/or sensors, task logging, check status, the ability to reassign and/or escalate a task, and/or the like. In some implementations, the task management platform can provide an application interface to access application data and capabilities for providing rider assistance such as vehicle information, accessing vehicle audio and/or video capabilities, task logging, the ability to reassign and/or escalate a task, and/or the like.

In some implementations, the task management platform can provide an application interface to access application data and capabilities related to fleet maintenance such as vehicle information, service thresholds (e.g., miles and/or hours to a required service, etc.), inventory management, vehicle history, task log, resolution, the ability to reassign and/or escalate a task, and/or the like. In some implementations, the task management platform can provide for displaying vehicle metadata such as vehicle identification number (VIN), vehicle year, current total mileage, current total run hours, and/or the like. In some implementations, the task management platform can provide for identifying data associated with parts required for a maintenance task, such as manufacturer, part description, part number, quantity, source, cost data, timing (e.g., delivery arrival schedule, etc.), part serial numbers (e.g., old part and new part, etc.), request additional parts, and/or the like. In some implementations, the task management platform can provide for identifying warranty details, such as ticket identifier, cause code, symptom code, operational number, technical journal identifier, repair summary, labor time, labor total, and/or the like. In some implementations, the task management platform can provide for identifying recall details.

According to another aspect of the present disclosure, a task management platform can provide for reporting associated with tasks. For example, in some implementations, the task management platform can provide analytics associated with task performance (e.g., response time, resolution time, single touch vs. escalations, etc.), productivity (median handle time, etc.), volume (inflow, tickets created, tickets resolved, etc.), and/or remote operators.

The systems and methods described herein provide a number of technical effects and benefits. For instance, the systems and methods described herein can provide a task management platform architecture that allows for streamlined remote task workflows for management of vehicles within a fleet. For example, a task management platform can provide for automatic detection of vehicle events and improved generation and handling of tasks associated with resolution of such vehicle events. As such, the overall efficiency of fleet resource management and ability to dynamically determine workflow implementations is improved.

The systems and methods of the present disclosure also provide an improvement to vehicle computing technology, such as autonomous vehicle computing technology. For instance, the systems and methods herein enable the vehicle technology to collect and provide detailed vehicle event information. For example, the systems and methods can allow one or more computing system(s) on-board an autonomous vehicle (and/or off-board a vehicle) to detect vehicle events for multiple vehicles within a fleet and provide for managing tasks related to detected vehicle events.

With reference to the figures, example embodiments of the present disclosure will be discussed in further detail.

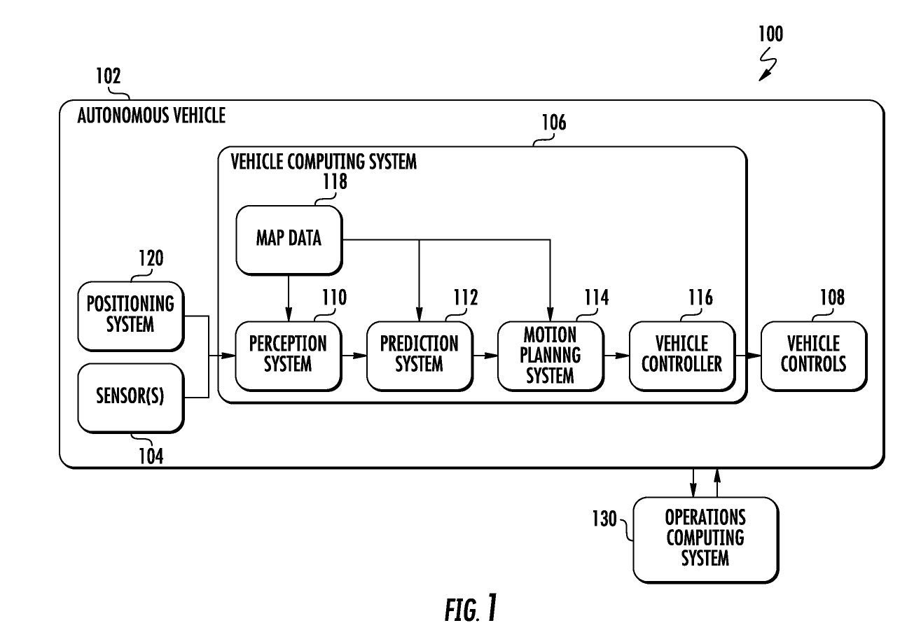

FIG. 1 depicts a block diagram of an example system 100 for controlling the navigation of an autonomous vehicle 102 according to example embodiments of the present disclosure. The system 100 can include a vehicle computing system 106 associated with the autonomous vehicle 102. In some implementations, the system 100 can include an operations computing system 130 that is remote from the autonomous vehicle 102.

The autonomous vehicle 102 is capable of sensing its environment and navigating with little to no human input. The autonomous vehicle 102 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 102 can be configured to operate in one or more modes, for example, a fully autonomous operational mode, semi-autonomous operational mode, and/or a non-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 102 can include one or more sensors 104, a vehicle computing system 106, and one or more vehicle controls 108. The vehicle computing system 106 can include one or more computing devices and include various subsystems that can assist in controlling the autonomous vehicle 102. In particular, the vehicle computing system 106 can receive sensor data from the one or more sensors 104, attempt to comprehend the surrounding environment by performing various processing techniques on data collected by the sensors 104, and generate an appropriate motion path through such surrounding environment. The vehicle computing system 106 can control the one or more vehicle controls 108 to operate the autonomous vehicle 102 according to the motion path.

Additionally, in some implementations, the vehicle computing system 106 can communicate with various data acquisition systems, autonomy systems, and/or vehicle control systems onboard the autonomous vehicle and obtain data indicative of one or more parameters associated with the vehicle. The vehicle computing system can be configured to determine the existence of a fault associated with the vehicle, for example, based in part on such parameter data. The vehicle computing system 106 can determine one or more actions to be performed by the autonomous vehicle to address the existence of the fault.

In some implementations, vehicle computing system 106 can include a positioning system 120. The positioning system 120 can determine a current position of the autonomous vehicle 102. The positioning system 120 can be any device or circuitry for analyzing the position of the autonomous vehicle 102. For example, the positioning system 120 can determine position by using one or more of inertial sensors, a satellite positioning system, based on IP address, by using triangulation and/or proximity to network access points or other network components (e.g., cellular towers, WiFi access points, etc.) and/or other suitable techniques for determining position. The position of the autonomous vehicle 102 can be used by various systems of the vehicle computing system 106.

As illustrated in FIG. 1, in some embodiments, the vehicle computing system 106 can include a perception system 110, a prediction system 112, and a motion planning system 114 that cooperate to perceive the surrounding environment of the autonomous vehicle 102 and determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a Light Detection and Ranging (LIDAR) system, a Radio Detection and Ranging (RADAR) system, one or more cameras (e.g., visible spectrum cameras, infrared cameras, etc.), and/or other sensors. The sensor data can include information that describes the location of objects within the surrounding environment of the autonomous vehicle 102.

As one example, for LIDAR system, the sensor data can include the location (e.g., in three-dimensional space relative to the LIDAR system) of a number of points that correspond to objects that have reflected a ranging laser. For example, LIDAR system can measure distances by measuring the Time of Flight (TOF) that it takes a short laser pulse to travel from the sensor to an object and back, calculating the distance from the known speed of light.

As another example, for RADAR system, the sensor data can include the location (e.g., in three-dimensional space relative to RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed. Thus, RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

In addition to the sensor data, the perception system 110 can retrieve or otherwise obtain map data 118 that provides detailed information about the surrounding environment of the autonomous vehicle 102. The map data 118 can provide information regarding: the identity and location of different travel ways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way); traffic control data (e.g., the location and instructions of signage, traffic lights, or other traffic control devices); and/or any other map data that provides information that assists the vehicle computing system 106 in comprehending and perceiving its surrounding environment and its relationship thereto.

The perception system 110 can identify one or more objects that within the surrounding environment of the autonomous vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed; current heading (also referred to together as velocity); current acceleration; current orientation; size/footprint (e.g., as represented by a bounding shape such as a bounding polygon or polyhedron); class (e.g., vehicle versus pedestrian versus bicycle versus other); yaw rate; uncertainties associated therewith, and/or other state information.

In some implementations, the perception system 110 can determine state data for each object over a number of iterations. In particular, the perception system 110 can update the state data for each object at each iteration. Thus, the perception system 110 can detect and track objects (e.g., vehicles, pedestrians, bicycles, and the like) that within the surrounding environment of the autonomous vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. For example, the prediction system 112 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction system 112 predicts the speed and/or acceleration at which the respective object is predicted to travel along its associated predicted motion trajectory. As one example, an object can be predicted to adhere to its current trajectory according to its current speed. As another example, other, more sophisticated prediction techniques or modeling can be used.

The motion planning system 114 can determine a motion plan for the autonomous vehicle 102 based at least in part on the predicted one or more future locations for the object provided by the prediction system 112 and/or the state data for the object provided by the perception system 110. Stated differently, given information about the current locations of objects and/or predicted future locations of proximate objects, the motion planning system 114 can determine a motion plan for the autonomous vehicle 102 that best navigates the autonomous vehicle 102 relative to the objects at such locations. The motion plan can include one or more vehicle trajectories that indicate how the vehicle 102 is to travel over a certain time period, distance, etc. This can indicate a vehicle heading, speed, acceleration, and/or other motion parameters. The motion planning system 114 can be configured to select a vehicle trajectory for implementation by the autonomous vehicle 102 to control its motion.

As one example, in some implementations, the motion planning system 114 can determine a cost function for each of one or more candidate vehicle trajectories for the autonomous vehicle 102 based at least in part on the current locations and/or predicted future locations of the objects. For example, the cost function can describe a cost (e.g., over time) of adhering to a particular candidate trajectory. For example, the cost described by a cost function can increase when the autonomous vehicle 102 approaches a possible impact with another object and/or deviates from a preferred pathway (e.g., a predetermined travel route).

Thus, given information about the current locations and/or predicted future locations of objects, the motion planning system 114 can determine a cost of adhering to a particular candidate pathway. The motion planning system 114 can select or determine a motion plan for the autonomous vehicle 102 based at least in part on the cost function(s). For example, the candidate motion plan that minimizes the cost function can be selected or otherwise determined. The motion planning system 114 can provide the selected motion plan to a vehicle controller 116 that controls one or more vehicle controls 108 (e.g., actuators or other devices that control gas flow, acceleration, steering, braking, etc.) to execute the selected motion plan.

Each of the perception system 110, the prediction system 112, the motion planning system 114, and the vehicle controller 116 can include computer logic utilized to provide desired functionality. In some implementations, each of the perception system 110, the prediction system 112, the motion planning system 114, and the vehicle controller 116 can be implemented in hardware, firmware, and/or software controlling a general purpose processor. For example, in some implementations, each of the perception system 110, the prediction system 112, the motion planning system 114, and the vehicle controller 116 includes program files stored on a storage device, loaded into a memory, and executed by one or more processors. In other implementations, each of the perception system 110, the prediction system 112, the motion planning system 114, and the vehicle controller 116 includes one or more sets of computer-executable instructions that are stored in a tangible computer-readable storage medium such as RAM hard disk or optical or magnetic media.

In some implementations, the autonomous vehicle 102 can be associated with an entity (e.g., a service provider, owner, manager). The entity can be one that offers one or more vehicle service(s) to a plurality of users via a fleet of vehicles that includes, for example, the autonomous vehicle 102. In some implementations, the operations computing system 130 can be associated with the entity. The entity can utilize the operations computing system 130 to coordinate and/or manage the autonomous vehicle 102 (and its associated fleet, if any) to provide the vehicle services to users.

The operations computing system 130 can include one or more computing devices that are remote from the autonomous vehicle 102 (e.g., located off-board the vehicle 102). For example, such computing device(s) can be components of a cloud-based server system and/or other type of computing system that can communicate with the vehicle computing system 106 of the autonomous vehicle 102. The computing device(s) of the operations computing system 130 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system 130 (e.g., the one or more processors, etc.) to perform operations and functions, such as providing data to and/or receiving data from the autonomous vehicle 102, for managing a fleet of vehicles (that includes the autonomous vehicle 102), etc.

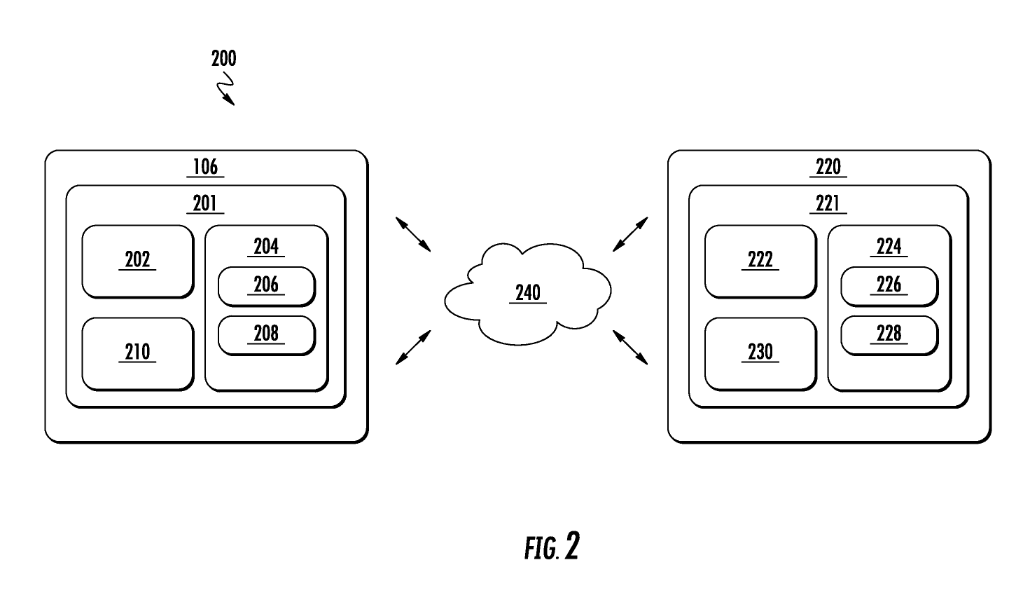

FIG. 2 depicts a block diagram of an example computing system 200 according to example embodiments of the present disclosure. The example system 200 illustrated in FIG. 2 is provided as an example only. The components, systems, connections, and/or other aspects illustrated in FIG. 2 are optional and are provided as examples of what is possible, but not required, to implement the present disclosure. The example system 200 can include the vehicle computing system 106 of the autonomous vehicle 102 and a remote computing system 220 (e.g., operations computing system, etc. that is remote from the vehicle 102) that can be communicatively coupled to one another over one or more network(s) 240. The remote computing system 220 can be associated with a central operations system and/or an entity associated with the vehicle 102 such as, for example, a vehicle owner, vehicle manager, fleet operator, service provider, etc. For instance, the remote computing system 220 can be or otherwise include the operations computing system 130 described herein.

The computing device(s) 201 of the vehicle computing system 106 can include processor(s) 202 and at least one memory 204. The one or more processors 202 can be any suitable processing device (e.g., a processor core, a microprocessor, an ASIC, a FPGA, a controller, a microcontroller, etc.) and can be one processor or a plurality of processors that are operatively connected. The memory 204 can include one or more non-transitory computer-readable storage media, such as RAM, ROM, EEPROM, EPROM, one or more memory devices, flash memory devices, magnetic disks, data registers, etc., and combinations thereof.

The memory 204 can store information that can be accessed by the one or more processors 202. For instance, the memory 204 (e.g., one or more non-transitory computer-readable storage mediums, memory devices) can include computer-readable instructions 206 that can be executed by the one or more processors 202. The instructions 206 can be software written in any suitable programming language or can be implemented in hardware. Additionally, or alternatively, the instructions 206 can be executed in logically and/or virtually separate threads on processor(s) 202.

For example, the memory 204 on-board the vehicle 102 can store instructions 206 that when executed by the one or more processors 202 cause the one or more processors 202 (e.g., in the vehicle computing system 106) to perform operations such as any of the operations and functions of the computing device(s) 201 and/or vehicle computing system 106, the operations and functions for managing a vehicle (e.g., one or more portions of operations 300), any of the operations and functions for which the vehicle computing system 106 is configured, and/or any other operations and functions of the vehicle computing system 106, as described herein.

The memory 204 can store data 208 that can be obtained (e.g., received, accessed, written, manipulated, created, generated, etc.) and/or stored. The data 208 can include, for instance, services data (e.g., trip data, user data, etc.), sensor data, map data, perception data, prediction data, motion planning data, object states and/or state data, object motion trajectories, feedback data, fault data, and/or other data/information as described herein. In some implementations, the computing device(s) 201 can obtain data from one or more memories that are remote from the autonomous vehicle 102.

The computing device(s) 201 can also include a communication interface 210 used to communicate with one or more other system(s) (e.g., the remote computing system 220). The communication interface 210 can include any circuits, components, software, etc. for communicating via one or more networks (e.g., network(s) 240). In some implementations, the communication interface 210 can include, for example, one or more of a communications controller, receiver, transceiver, transmitter, port, conductors, software, and/or hardware for communicating data.

The remote computing system 220 can include one or more computing device(s) 221. The computing device(s) 221 can include one or more processors 222 and at least one memory 224. The one or more processors 222 can be any suitable processing device (e.g., a processor core, a microprocessor, an ASIC, a FPGA, a controller, a microcontroller, etc.) and can be one processor or a plurality of processors that are operatively connected. The memory 224 can include one or more tangible, non-transitory computer-readable storage media, such as RAM, ROM, EEPROM, EPROM, one or more memory devices, flash memory devices, data registers, etc., and combinations thereof.

The memory 224 can store information that can be accessed by the one or more processors 222. For instance, the memory 224 (e.g., one or more tangible, non-transitory computer-readable storage media, one or more memory devices, etc.) can include computer-readable instructions 226 that can be executed by the one or more processors 222. The instructions 226 can be software written in any suitable programming language or can be implemented in hardware. Additionally, or alternatively, the instructions 226 can be executed in logically and/or virtually separate threads on processor(s) 222.

For example, the memory 224 can store instructions 226 that when executed by the one or more processors 222 cause the one or more processors 222 to perform operations such as any of the operations and functions of the remote computing system 220 and/or computing device(s) 221 or for which the remote computing system 220 is configured, as described herein, and/or any other operations and functions described herein.

The memory 224 can store data 228 that can be obtained and/or stored. The data 228 can include, for instance, services data (e.g., trip data, user, data etc.), data associated with autonomous vehicles (e.g., vehicle data, maintenance data, ownership data, sensor data, map data, perception data, prediction data, motion planning data, object states and/or state data, object motion trajectories, feedback data, fault data, etc.), inventory data, scheduling data, and/or other data/information as described herein. In some implementations, the computing device(s) 221 can obtain data from one or more memories that are remote from the remote computing system 220.

The computing device(s) 221 can also include a communication interface 230 used to communicate with one or more other system(s) (e.g., the vehicle computing system 106, etc.). The communication interface 230 can include any circuits, components, software, etc. for communicating via one or more networks (e.g., network(s) 240). In some implementations, the communication interface 230 can include, for example, one or more of a communications controller, receiver, transceiver, transmitter, port, conductors, software, and/or hardware for communicating data.

The network(s) 240 can be any type of network or combination of networks that allows for communication between devices. In some embodiments, the network(s) 240 can include one or more of a local area network, wide area network, the Internet, secure network, cellular network, mesh network, peer-to-peer communication link, and/or some combination thereof, and can include any number of wired or wireless links. Communication over the network(s) 240 can be accomplished, for instance, via a communication interface using any type of protocol, protection scheme, encoding, format, packaging, etc.

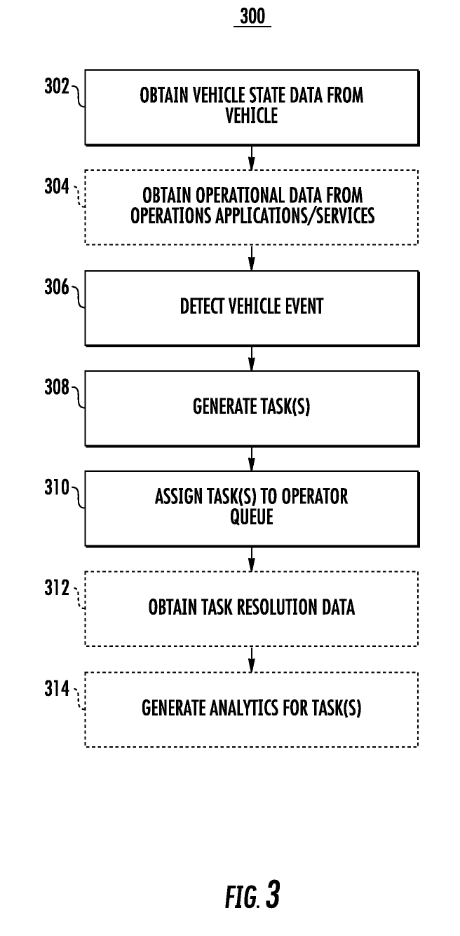

FIG. 3 depicts a flowchart diagram of example operations 300 for a task management platform according to example embodiments of the present disclosure. As described herein, a task management platform can provide task workflow capabilities, such as task queuing, prioritization, routing, escalation, analytics, and reporting, for managing vehicles across a fleet. The task management platform can provide for detecting vehicle events, generating one or more tasks associated with the vehicle events for one or more remote operators (e.g., remote operators managing a fleet in an entity's operations/control center, and facilitating resolution of the one or more tasks. One or more portion(s) of the operations 300 can be implemented by one or more computing devices such as, for example, the vehicle computing system 106 of FIG. 1 or 2, the operations computing system 130 of FIG. 1, the remote computing system 220 of FIG. 2, and/or the like. Each respective portion of the operations 300 can be performed by any (or any combination) of the one or more computing devices. Moreover, one or more portion(s) of the operations 300 can be implemented as an algorithm on the hardware components of the device(s) described herein (e.g., as in FIGS. 1 and 2), for example, to provide for management of vehicles in a service fleet. FIG. 3 depicts elements performed in a particular order for purposes of illustration and discussion and is not meant to be limiting.

At 302, one or more computing devices included within a computing system (e.g., computing system 106, 130, 220, and/or the like) can obtain vehicle state data from one or more vehicles in a fleet. For example, the computing system can communicate with one or more vehicles (e.g., vehicle computing system, etc.) to obtain vehicle state data (e.g., vehicle activity information, vehicle schedule information, trip availability information, vehicle readiness information, vehicle ownership information, vehicle failure/error data, and/or the like) associated with the one or more vehicles.

At 304, the computing system can, optionally, obtain operational data from one or more applications and/or services operating on computing systems within an entity's operations/control center. For example, in some implementations, the computing system can obtain operational data from one or more applications/services and/or data stores, for example, operating/housed within the entity's operations/control center and/or the like, for use in determining vehicle events and/or tasks associated with vehicle events.

At 306, the computing system can detect a vehicle event associated with one of the one or more vehicles in the fleet, based at least in part on the vehicle state data. For example, the computing system can perform anomaly detection to identify vehicle events based at least in part on the vehicle state data (and, optionally, on the operational data).

At 308, the computing system can generate one or more tasks based in part on the detected vehicle event. As an example, a vehicle event can be an indication that a check engine light has been triggered in a vehicle. The check engine light vehicle event could trigger a fleet management task to schedule vehicle maintenance, which may then be escalated or routed to fleet services such that a required part can be ordered. Once the part order has been received, the vehicle could be scheduled for maintenance.

At 310, the computing system can assign the one or more tasks to one or more remote operator queues. For example, the computing system can categorize, prioritize, and queue the tasks associated with vehicle events. In some implementations, the computing system can route tasks to one or more remote operators (e.g., in an entity's operations/control center) based in part on skill sets associated with the remote operators.

In some implementations, the computing system can provide for remote operators to view, sort, and/or filter queued tasks. For example, the computing system can provide a view of queued tasks and display associated task information, such as application, task title, task number, associated vehicle, vehicle location, vehicle mission, vehicle system information, task status, assigned operator, and/or the like. In some implementations, the task management platform can provide for reassigning tasks to another operator.

In some implementations, the computing system can provide interfaces to one or more other operations applications/services and or data stores (e.g., operating/housed within the entity's operations/control center, etc.), for example, to facilitate resolving and/or escalating a task. For example, in some implementations, the task management platform can access one or more other applications/services and obtain data and/or provide access to application functionality for use in handling tasks. In some implementations, the task management platform can provide an interface to one or more application-specific components, for example, external video, internal video, vehicle diagnostics, inventory data, and/or the like.

At 312, the computing system can, optionally, obtain task resolution data for one of the one or more tasks. For example, the computing system can obtain resolution data, such as resolution history (e.g., actions performed, related knowledgebase data, etc.), task status (e.g., completed/closed, escalated, duration, etc.), and/or the like. In some implementations, the task computing system can provide for a task log to allow for logging all associated task data and/or actions.

At 314, the computing system can, optionally, generate analytics based at least in part on the one or more tasks. For example, the computing system can obtain data related to tasks and/or remote operators (e.g., resolution data, task log data, etc.) and generate reporting/analytics based on one or more metrics. For instance, in some implementations, the computing system can provide analytics associated with task performance (e.g., response time, resolution time, single touch vs. escalations, etc.), productivity (median handle time, etc.), volume (inflow, tickets created, tickets resolved, etc.), and/or remote operators.

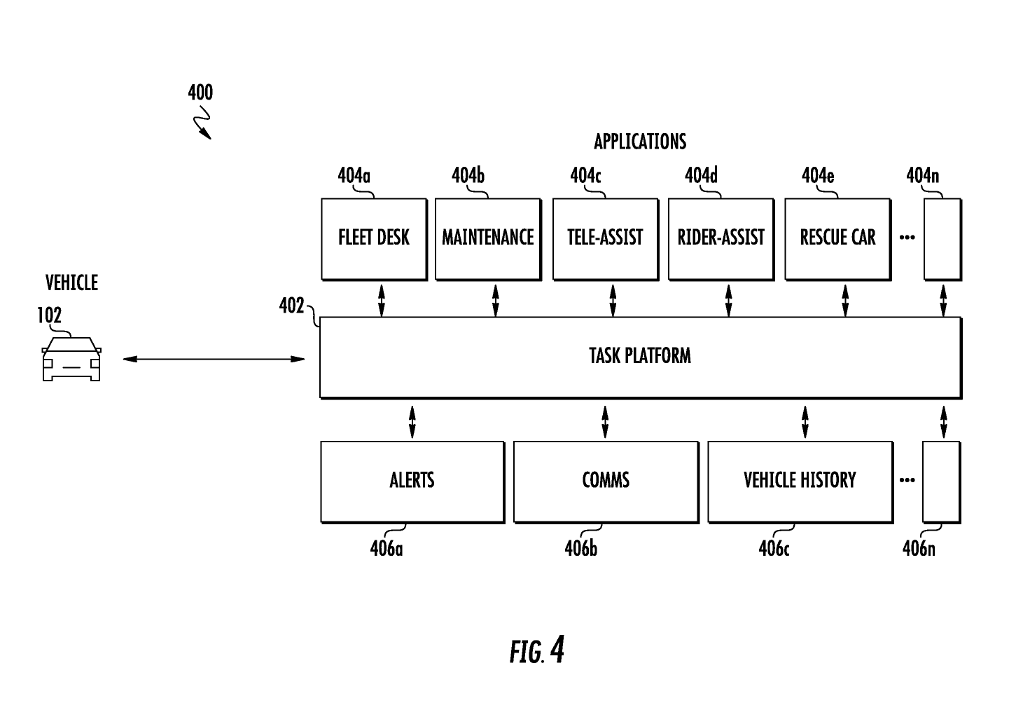

FIG. 4 depicts a block diagram of an example task management system 400 according to example embodiments of the present disclosure. The example task management system 400 illustrated in FIG. 4 is provided as an example only. The components, systems, connections, and/or other aspects illustrated in FIG. 4 are optional and are provided as examples of what is possible, but not required, to implement the present disclosure. The example task management system 400 can include one or more autonomous vehicles 102 and a task management platform 402 that can be communicatively coupled over one or more networks. The example task management system 400 can further include one or more applications/services 404a-404n and one or more data stores 406a-406n that can be communicatively coupled to task management platform 402 over one or more networks.

As described herein, the task management system 400 can allow for monitoring the health of vehicles across an entity's fleet. The task management system 400 can provide task workflow capabilities, such as task queuing, prioritization, routing, escalation, analytics, and reporting, for managing vehicles across the entire fleet. The task management platform 402 can provide for detecting vehicle events and generating one or more tasks associated with the vehicle events for one or more remote operators (e.g., remote operators managing a fleet in an entity's operations/control center), for example, based at least in part on data obtained from the one or more autonomous vehicles 102, the one or more applications/services 404a-404n, and/or the one or more data stores 406a-406n.

In some implementations, the task management platform 402 can communicate with one or more autonomous vehicles 102 (e.g., vehicle computing system, etc.) within an entity's fleet to obtain data for use in the detection of vehicle events. In some implementations, a vehicle API platform and/or the like can allow for an autonomous vehicle 102 to send data including vehicle state data (e.g., vehicle activity information, vehicle schedule information, trip availability information, vehicle readiness information, vehicle ownership information, vehicle failure/error data, and/or the like) associated at one or more times. The task management platform 402 can obtain the vehicle state data for use in determining whether a vehicle event has occurred, such as when vehicle metrics deviate from normal or historical trends.

In some implementations, the task management platform 402 can additionally communicate with one or more applications/services (e.g., applications/services, f404a-404n) and/or data stores (e.g., data stores 406a-406n), operating/housed within the entity's operations/control center and/or the like, to obtain operational data for use in determining vehicle events and/or tasks associated with vehicle events. For example, the task management platform 402 can obtain data from applications/services 404a-404n (e.g., fleet management, maintenance, etc.), such as vehicle service history, vehicle recall information, fleet metrics, operating parameters, and/or the like, to assist in determining whether one or more tasks should be generated in regard to a detected vehicle event.

The task management platform 402 can generate one or more tasks based in part on the vehicle event(s). In some implementations, the task management platform can provide data to the one or more vehicles 102 (e.g., vehicle computing system, etc.) for use in resolving issues associated with the vehicle event(s). The task management platform 402 can route tasks to one or more remote operators (e.g., in an entity's operations/control center, etc.) based in part on skill sets associated with each remote operator. The task management platform 402 can provide for remote operators to view, sort, and/or filter assigned tasks. For example, in some implementations, the task management platform 402 can provide a queue of assigned tasks and display task information associated with each queued task.

In some implementations, the task management platform 402 can provide interfaces to one or more other operations applications/service 404a-404n (e.g., operating within the entity's operations/control center, etc.) to facilitate resolving and/or escalating a task. For example, in some implementations, the task management platform 402 can access one or more other applications/services 404a-404n and obtain data and/or provide access to application functionality for use in handling tasks.

In some implementations, the task management platform 402 can provide for logging all tasks and/or associated actions, as well as capturing comments/information related to a task/action. In some implementations, the task management platform 402 can provide the logged information for use in a vehicle history. In some implementations, the task management platform 402 can provide for using the logged information, as well as other task-related information, for generating reporting/analytics associated with tasks. For example, in some implementations, the task management platform 402 can provide analytics associated with task performance (e.g., response time, resolution time, single touch vs. escalations, etc.), productivity (median handle time, etc.), volume (inflow, tickets created, tickets resolved, etc.), and/or remote operators.

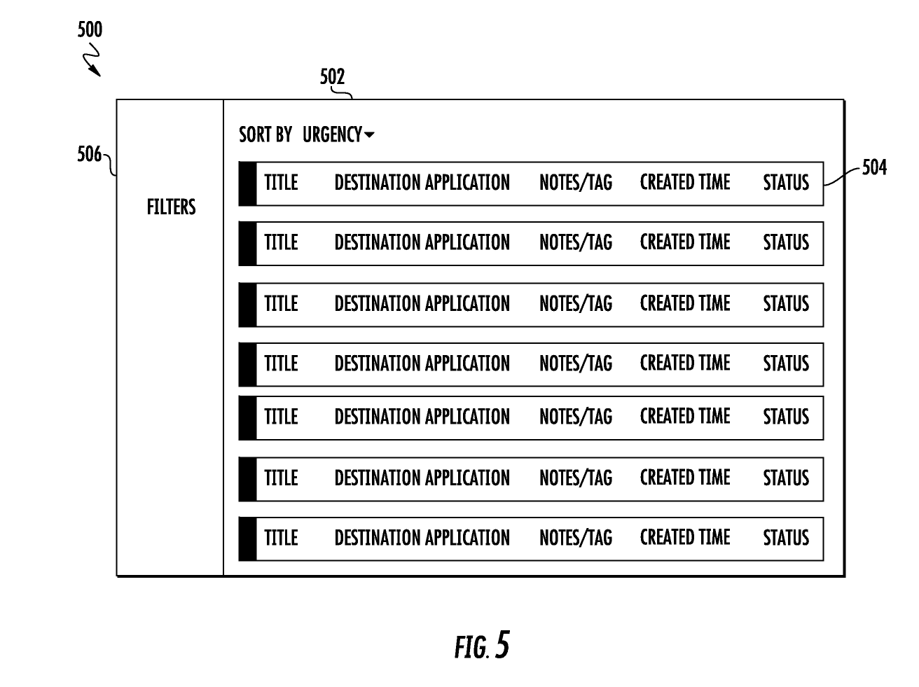

FIG. 5 depicts an example display interface 500 for task queuing according to example embodiments of the present disclosure. As described herein, a task management platform can provide for detecting a vehicle event and generating one or more tasks associated with the vehicle event for one or more remote operators (e.g., remote operators managing a fleet in an entity's operations/control center). For example, the task management platform can facilitate monitoring fleet health, for example using real-time dashboards, and can provide for alerts when key metrics deviate from normal or historical trends, such as identified via anomaly detection.

In some embodiments, the task management platform can categorize, prioritize and queue tasks associated with vehicle events. For example, in some implementations, the task management platform can route tasks to one or more remote operators (e.g., in an entity's operations/control center) based in part on skill sets associated with each of the remote operators. In some implementations, the task management platform can provide for generating profiles for remote operators, for example, to maintain historical and reporting data for remote operators. In some implementations, the task management platform can provide for generating and/or associating one or more skill sets for a remote operator (e.g., in an operator profile, etc.) to facilitate routing tasks to a remote operator.

As illustrated in FIG. 5, in some implementations, the task management platform can provide a task queue display interface 500 to allow remote operators to view, sort, and/or filter one or more assigned tasks. For example, in some implementations, the task queue display interface 500 can provide a list view 502 of assigned tasks 504, and display associated task information, such as application, task title, task identifier (e.g., task number), task status, timestamp (e.g., when task was generated, when status changed, etc.), associated vehicle, vehicle location (e.g., city, etc.), vehicle mission, vehicle system information (e.g., current system release, etc.), task status (e.g., opened, closed, duration, etc.), assigned operator, and/or the like. In some implementations, the task queue display interface 500 can allow a remote operator to apply one or more filters 506 to filter the one or more displayed tasks 504 in the queue list view 502, for example, filtering by time period, by status (e.g., open, closed, etc.), by one or more task fields, and/or the like.

In some implementations, the task management platform and/or task queue display interface 500 can provide for reassigning tasks to another remote operator, for example, as a result of change in availability and/or the like. For example, in some implementations, the task management platform and/or task queue display interface 500 can provide for indicating that a remote operator is going offline and allow one or more tasks to be reassigned to another remote operator. In some implementations, the task management platform and/or task queue display interface 500 can provide for indicating that a remote operator is going online and allowing one or more tasks to be assigned to the remote operator.

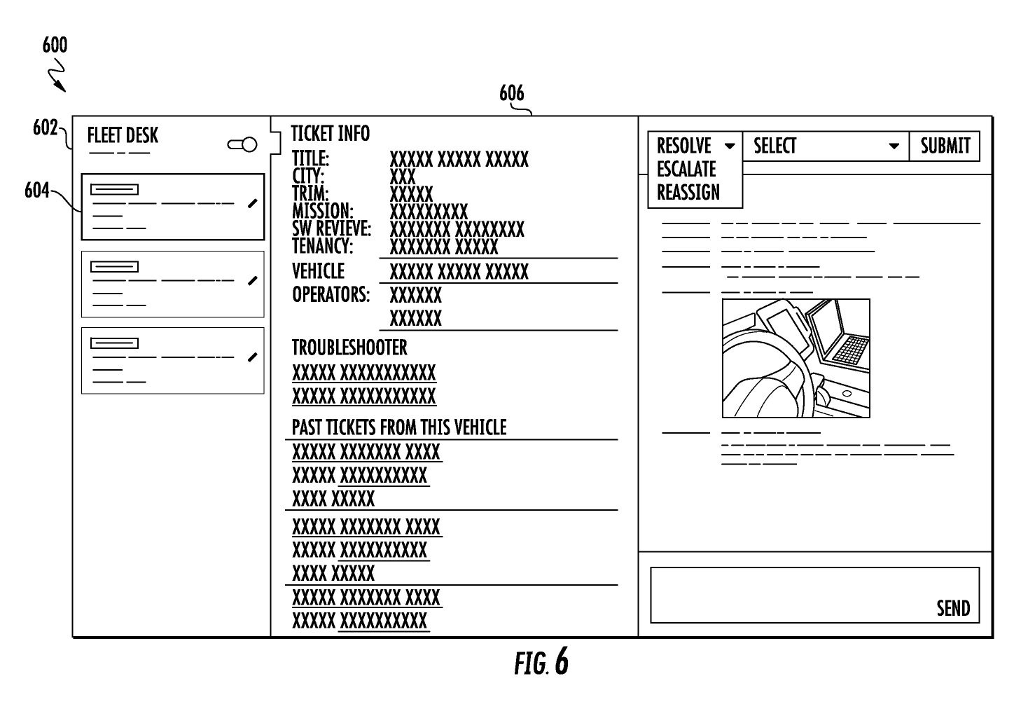

FIG. 6 depicts an example display interface 600 for task resolution according to example embodiments of the present disclosure. In some implementations, a task management platform can provide interfaces to one or more other operations applications/services (e.g., operating within the entity's operations/control center, etc.) to facilitate resolving and/or escalating a task. For example, in some implementations, the task management platform can access one or more other applications/services and obtain data and/or provide access to application functionality for use in addressing/resolving tasks. In some implementations, the task management platform can provide an interface to one or more application-specific components, for example, external video, internal video, vehicle diagnostics, inventory data, and/or the like.

As illustrated in FIG. 6, a task management platform can provide a task/application display interface 600 for viewing one or more queued tasks associated with an application/service (e.g., fleet management, fleet maintenance, etc.) and/or assigned to a remote operator associated with the application/service, as well as providing an interface to the application/service data and/or functionality. For example, a task/application display interface 600 may include a queued tasks panel 602 which can display the one or more open tasks 604 associated with the application/service and assigned to a remote operator. In some implementations, the task management platform can provide common display header data associated with a task as part of an interface 600 for an operations application/service, for example, in queued tasks panel 602. For example, in some implementations, the queued tasks panel 602 can display data indicative of the one or more tasks associated with the application/service, such as ticket identifiers, status (e.g., online, offline, etc.), number of tickets in queue, and/or the like.

The task/application display interface 600 may include an application/service interface 606 providing access/display of application/service data and/or functionality. For example, in some implementations, the application/service interface 606 can provide for facilitating one or more actions related to a task. For example, a task management platform application/service interface 606 can provide the ability to execute a command remotely to troubleshoot and/or resolve an issue, update one or more diagnostics, view a history of vehicle diagnostic snapshots, access one or more knowledge bases, escalate a task, record a task resolution, reopen a task, and/or the like. In some implementations, the task management platform can provide for a task log to allow for logging all associated tasks and/or actions, and can provide for capturing comments related to a task/action.

As one example, in some implementations, the task management platform can provide an application/service interface 606 to access application data and capabilities related to fleet management such as vehicle information, troubleshooter information/capabilities, vehicle history, task log, resolution, the ability to reassign and/or escalate a task, and/or the like. In some implementations, the task management platform can provide for displaying key task and/or vehicle information associated with the application. For example, the application/service interface 606 can provide for the display of task information such as task number, task title, task category, task priority, and/or the like. As another example, the task management platform application interface can provide for the display of vehicle information such as vehicle identifier (e.g., alias, etc.), current city, mission, operators, links, troubleshooter/update capability, and/or the like. In some implementations, the application/service interface 606 can provide for accessing a task history for a vehicle, for example, providing a view of all tasks associated with the vehicle over a defined period (e.g., last three tasks, tasks in last 30 days, etc.).

As another example, in some implementations, the task management platform can provide an application/service interface 606 to access application data and capabilities for pre and/or post assignment vehicle checks such as vehicle information, pre-assignment check, post-assignment check, access vehicle cameras and/or sensors, task logging, check status, the ability to reassign and/or escalate a task, and/or the like. In some implementations, the task management platform can provide an application/service interface 606 to access application/service data and capabilities for providing rider assistance such as vehicle information, accessing vehicle audio and/or video capabilities, task logging, the ability to reassign and/or escalate a task, and/or the like.

As another example, in some implementations, the task management platform can provide an application/service interface 606 to access application data and capabilities related to fleet maintenance such as vehicle information, service thresholds (e.g., miles and/or hours to a required service, etc.), inventory management, vehicle history, task log, resolution, the ability to reassign and/or escalate a task, and/or the like. In some implementations, the application/service interface 606 can provide for displaying vehicle metadata such as vehicle identification number (VIN), vehicle year, current total mileage, current total run hours, and/or the like. In some implementations, the task management platform can provide for identifying data associated with parts required for a maintenance task, such as manufacturer, part description, part number, quantity, source, cost data, timing (e.g., delivery arrival schedule, etc.), part serial numbers (e.g., old part and new part, etc.), request additional parts, and/or the like. In some implementations, the task management platform can provide for identifying warranty details, such as ticket identifier, cause code, symptom code, operational number, technical journal identifier, repair summary, labor time, labor total, and/or the like. In some implementations, the task management platform can provide for identifying recall details.

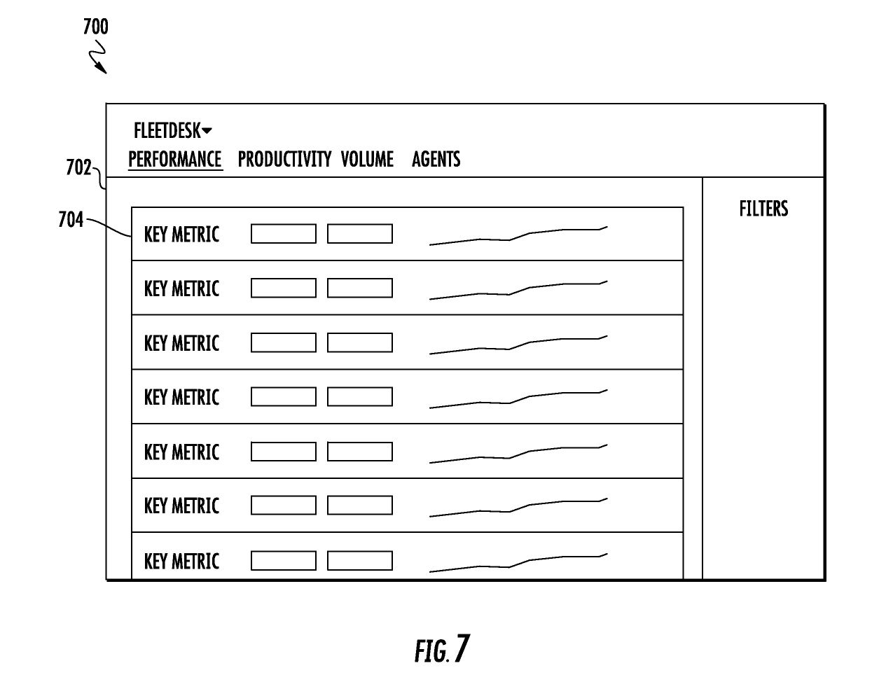

FIG. 7 depicts an example display interface 700 for analytics reporting according to example embodiments of the present disclosure. In some implementations, a task management platform can provide for collecting and analyzing information associated with one or more tasks, operators, and/or vehicles to provide analytics and reporting. For example, in some implementations, the task management platform can provide analytics associated with task performance (e.g., response time, resolution time, single touch vs. escalations, etc.), productivity (median handle time, etc.), volume (inflow, tickets created, tickets resolved, etc.), and/or remote operators. As illustrated in FIG. 7, the task management platform can provide a display interface for viewing the analytics and reporting information. For example, a reporting display interface 700 may include one or more panels 702 to display one or more categories/types of analytics or reporting information, such as performance reporting, productivity reporting, volume reporting, and/or agent reporting. In some implementations, each reporting panel 702 can display one or more different types of analytical/reporting metrics 704. As an example, a reporting panel 702 may display one or more performance metrics such as response time, resolution time, single touch vs. escalations, and/or the like. As another example, a reporting panel 702 may display one or more productivity metrics such as median handling time and/or the like. As another example, a reporting panel 702 may display one or more volume metrics such as inflow, tickets created, tickets resolved, and/or the like.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for managing a fleet of vehicles, the method comprising:
obtaining, by a computing system comprising one or more computing devices, vehicle state data indicative of vehicle state from one or more vehicles among a fleet of vehicles;
determining, by the computing system, if a vehicle event has occurred based at least in part on the vehicle state data;
in response to determining a vehicle event has occurred, generating, by the computing system, one or more tasks for resolution of the vehicle event, wherein the one or more tasks include data associated with the one or more vehicles and the vehicle event; and
providing, by the computing system, data associated with the one or more tasks to a remote operator computing system.

2. The computer-implemented method of claim 1, further comprising:
obtaining, by the computing system, operational data associated with the one or more vehicles from one or more applications within an operations system; and
determining, by the computing system, if a vehicle event has occurred based at least in part on the vehicle state data and the operational data associated with the one or more vehicles.

3. The computer-implemented method of claim 1, further comprising:
obtaining, by the computing system, data indicative of performance of the one or more tasks; and
generating, by the computing system, analytic data based at least in part on the data indicative of performance of the one or more tasks.

4. The computer-implemented method of claim 1, further comprising:
accessing, by the computing system, one or more applications associated with performing the one or more tasks;
obtaining, by the computing system, data indicative of one or more operations associated with the one or more tasks; and
providing, by the computing system, the data indicative of one or more operations to the one or more applications.

5. The computer-implemented method of claim 4, wherein obtaining, by the computing system, data indicative of one or more operations associated with the one or more tasks comprises providing access to one or more application-specific components of the one or more applications.

6. The computer-implemented method of claim 1, wherein generating, one or more tasks for resolution of the vehicle event comprises categorizing and prioritizing the one or more tasks.

7. The computer-implemented method of claim 1, wherein providing data associated with the one or more tasks to a remote operator computing system comprises routing the one or more tasks to a remote operator queue based at least in part on assigned operator skill sets.

8. A system comprising:
one or more processors; and
memory including instructions that, when executed by the one or more processors, cause the one or more processors to perform operations, the operations comprising:
obtaining vehicle state data indicative of vehicle state from one or more vehicles among a fleet of vehicles;
determining if a vehicle event has occurred based at least in part on the vehicle state data;
in response to determining a vehicle event has occurred, generating one or more tasks for resolution of the vehicle event, wherein the one or more tasks include data associated with the one or more vehicles and the vehicle event; and
providing data associated with the one or more tasks to a remote operator computing system.

9. The system of claim 8, the operations further comprising:
obtaining operational data associated with the one or more vehicles from one or more applications within an operations system; and
determining if a vehicle event has occurred based at least in part on the vehicle state data and the operational data associated with the one or more vehicles.

10. The system of claim 8, the operations further comprising:
obtaining data indicative of performance of the one or more tasks; and
generating analytic data based at least in part on the data indicative of performance of the one or more tasks.

11. The system of claim 8, the operations further comprising:
accessing one or more applications associated with performing the one or more tasks;
obtaining data indicative of one or more operations associated with the one or more tasks; and
providing the data indicative of one or more operations to the one or more applications.

12. The system of claim 11, wherein obtaining data indicative of one or more operations associated with the one or more tasks comprises providing access to one or more application-specific components of the one or more applications.

13. The system of claim 8, wherein generating one or more tasks for resolution of the vehicle event comprises categorizing and prioritizing the one or more tasks.

14. The system of claim 8, wherein providing data associated with the one or more tasks to a remote operator computing system comprises routing the one or more tasks to a remote operator queue based at least in part on assigned operator skill sets.

15. One or more tangible, non-transitory computer-readable media storing computer-readable instructions that when executed by one or more processors cause the one or more processors to perform operations, the operations comprising:
obtaining vehicle data indicative of vehicle state from one or more vehicles among a fleet of vehicles;
determining if a vehicle event has occurred based at least in part on the vehicle state data;
in response to determining a vehicle event has occurred, generating one or more tasks for resolution of the vehicle event, wherein the one or more tasks include data associated with the one or more vehicles and the vehicle event; and
providing data associated with the one or more tasks to a remote operator computing system.

16. The one or more tangible, non-transitory computer-readable media of claim 15, the operations further comprising:
obtaining operational data associated with the one or more vehicles from one or more applications within an operations system; and
determining if a vehicle event has occurred based at least in part on the vehicle state data and the operational data associated with the one or more vehicles.

17. The one or more tangible, non-transitory computer-readable media of claim 15, the operations further comprising:
obtaining data indicative of performance of the one or more tasks; and
generating analytic data based at least in part on the data indicative of performance of the one or more tasks.

18. The one or more tangible, non-transitory computer-readable media of claim 15, the operations further comprising:
accessing one or more applications associated with performing the one or more tasks;
obtaining data indicative of one or more operations associated with the one or more tasks; and
providing the data indicative of one or more operations to the one or more applications.

19. The one or more tangible, non-transitory computer-readable media of claim 18 wherein obtaining data indicative of one or more operations associated with the one or more tasks comprises providing access to one or more application-specific components of the one or more applications.

20. The one or more tangible, non-transitory computer-readable media of claim 15 wherein providing data associated with the one or more tasks to a remote operator computing system comprises routing the one or more tasks to a remote operator queue based at least in part on assigned operator skill sets.
